(19) United States
(12) Patent Application Publication
(10) Pub. No.: US 2009/0149589 A1
(43) Pub. Date: Jun. 11, 2009

(54) METHOD FOR GENERATING SURFACE-SILVERED POLYMER STRUCTURES

(75) Inventors: David W. Thompson, Williamsburg, VA (US); Luke M. Davis, Ashland, VA (US); Christopher J. Abelt, Williamsburg, VA (US)

Correspondence Address: WILLIAM AND MARY TECHNOLOGY TRANSFER OFFICE, 402 JAMESTOWN RD, PO BO 8795, WILLIAMSBURG, VA, 23187-8795, US

(73) Assignee: COLLEGE OF WILLIAM AND MARY, Williamsburg, VA (US)

(21) Appl. No.: 11/950,475

(22) Filed: Dec. 5, 2007

(51) Int. Cl. C08L 77/00

(52) U.S. Cl. 524/403; 524/780

(57) ABSTRACT

A process is described for forming a conductive silver surface on a solid polymer article. An acid-containing polymer and silver ions are dissolved in an appropriate solvent, and a solid polymer article is formed by known methods. The solid polymer is treated with a chemical reducing agent to yield a conductive silver surface, useful in a wide range of applications. Patterned silver conductive surfaces can also be produced.

### CROSS-REFERENCE TO RELATED APPLICATIONS

Not applicable

### STATEMENT REGARDING FEDERALLY SPONSORED RESEARCH AND DEVELOPMENT

Not applicable

### FIELD OF INVENTION

The field of the invention relates to the fabrication of surface-silvered polymer substrates as films, coatings, devices, and objects.

### BACKGROUND OF THE INVENTION

Surface-metallized polymer films are frequently prepared using either physical metal vapor deposition or electroless metal deposition. These processes require at least two distinct and separate stages: 1) preparation of the polymer film, and 2) subsequent deposition of the metal. For passive or noble metals such as silver, palladium, and gold, adhesion of the metal to the polymer is often inadequate.

Alternative polymer surface metallization protocols for silver that yield excellent metal-polymer adhesion have been described by Thompson et al. in U.S. Pat. No. 5,677,418 and U.S. Pat. No. 6,019,926. These patents teach methods to cast polymer/metal ion/solvent compositions into films, after which the films are subjected to a processing protocol involving thermal treatment at high temperatures in order to produce a metallized surface.

Another surface metallization procedure for polyimides has been described by Akamatsu et al. (K. Akamatsu, S. Ikeda, and H. Nawafune, Langmuir (2003) 19, 10366-10371). In this procedure, a solid polyimide film was treated with high concentrations of aqueous potassium hydroxide to convert surface imide groups to potassium amic-carboxylate groups. The film was then immersed in a silver(I) nitrate solution with potassium ions being exchanged stoichiometrically for silver(I) ions at the hydrolyzed surface of the polymer film. Subsequent processing steps produce a silver film on the surface.

A further procedure for metallizing polymer surfaces has been described by Chang et al. (T. C. Chou, J. Appl. Polym. Sci., (2004) 91, 270-273). This method teaches the co-dissolution of silver nitrate and a polymer (e.g., poly(vinyl alcohol), poly(amide imide)s, poly(vinyl acetate), a polyamide, a poly(acrylamide), or a polyurethane) in a suitable solvent. A cast film was then treated with a reducing agent to develop a silvered surface. This method does not teach the dissolution of silver salts with polymers that contain pendant acid groups, and this method requires relatively high concentrations of silver in order to achieve highly conductive films.

### BRIEF SUMMARY OF THE INVENTION

The disclosed invention is a process for taking poly(amic acid)s, mixed poly(amic acid)-polyimides, polyimides, and other polymers which have pendant acid groups such as carboxylic acid or carboxylate groups or sulfonic acid or sulfonate groups or other acid groups, and making these polymers optically reflective and electrically conductive in such a manner that the polymers as films, coatings, devices, and objects can be used to produce: 1) metallic electrical circuits, contacts, or pads on dielectric platforms, 2) metallic antennas on and embedded in dielectric materials, 3) metallic coatings and housings for electromagnetic shielding, 4) electromagnetic radiation reflective metallized films (mirrors) on flexible dielectric bases, 5) anti-static, charge dissipative coatings, 6) anti-infective coatings, 7) decorative objects, and 8) reflective metallic interiors of hollow waveguides.

More specifically, the present invention describes a method for forming a conductive silver coating on the surface of a solid polymer article comprising:
(i) dissolving silver ions in a solution comprising polymers or polymer precursors containing pendant acid groups;
(ii) producing a solid polymer article from said solution; and
(iii) treating the surface of said solid polymer article with a chemical reducing agent;
   thereby yielding a conductive silver coating on the surface of the polymer.

The present invention is a simple and efficient process for producing polymer articles having a conductive silver surface. A suitable solvent is used to dissolve silver ions and polymers or polymer precursors. In some embodiments, the polymer or polymer precursors can act as the solvent. The silver ion-polymer solution is then rendered to a film, coating, device, or object by techniques such as casting, spraying, immersing, brushing, printing, molding, and the like. Solvent is removed from the resulting films, coatings, devices, and objects via methods such as heating, subjecting to vacuum, evaporation in a stream of flowing gas, and passive evaporation. The solvent-diminished films are then subjected to a chemical reducing agent, in solution or in the vapor phase, to reduce metal ions to the native metallic state with its concomitant properties of optical reflectivity and electrical conductivity in various admixtures. Before treating with a reducing agent, the metal ion-doped films may be pretreated with a suitable metal ion-complexing agent such as ammonia, thiosulfate, or cyanide to enhance formation of a metallic surface.

Polymer films and articles having silver surface patterns can be generated by a number of different techniques according to the methods of the invention. For example, suitable masking and unmasking agents can be used to create intricate patterns. Additionally, the silver ion-polymer solution can be printed onto to a substrate to produce a conductive pattern, with no requirement for masking and unmasking steps.

### BRIEF DESCRIPTION OF THE DRAWINGS

The summary above, and the following detailed description, will be better understood in view of the drawings which depict details of preferred embodiments.

FIG. 1 shows a schematic diagram of a method for fabricating fully surface-silvered polymer films in accordance with the methods of the present invention.

FIG. 2 shows a schematic diagram of a method for fabricating silver surface-patterned polymer films in accordance with one embodiment of the present invention.

FIG. 3 shows a schematic diagram of an additional method for fabricating silver surface-patterned polymer films in accordance with an embodiment of the present invention.

FIG. 4 shows a schematic diagram of an additional method for fabricating silver surface-patterned polymer films in accordance with an embodiment of the present invention.

FIG. 5 shows a schematic diagram of an additional method for fabricating silver surface-patterned polymer films in accordance with an embodiment of the present invention.

### DETAILED DESCRIPTION OF THE INVENTION

The present invention is directed to methods for forming a conductive silver surface on a solid polymer article.

As used herein, a polymer containing “pendant acid groups” refers to polymers having pendant carboxylic acid or sulfonic acid groups in the main chain of the polymer, and does not refer to polymers with an acid group only at the chain terminus, or polymers only having latent acid groups. In this definition, the term “pendant acid groups” includes both protonated and deprotonated forms of carboxylic and sulfonic acids, i.e., both carboxylic acid groups and carboxylate groups are classified as acids herein.

Suitable examples of polymers containing pendant acid groups include poly(amic acids), mixed poly(amic acid)-polyimides, polyimides containing pendant acid groups, and polyacrylates. All poly(amic acid) polymers, mixed poly(amic acid)-polyimides, and polyacrylates contain pendant acid groups. Obviously, not all polyimides contain pendant acid groups, and the invention described herein is applicable only to those polyimides containing pendant acid groups. Without wishing to be bound by theory, it is believed that the pendant acid groups enhance the mobility of silver within the polymer matrix, facilitating the migration to the surface that is necessary during the reduction step to produce the desired highly conductive coatings.

Poly(amic acids) can be synthesized by reacting one or more dianhydrides and one or more diamines in a compatible solvent. Polyimides are frequently synthesized from poly(amic acid) precursors via chemical imidization with an acid anhydride and organic amine, or via thermal imidization. Polyimides and poly(amic acids) are also commercially available. Suitable polyacrylates include but are not limited to poly(ethyl acrylate-co-acrylic acid), poly(methacrylic acid), poly(methyl methacrylate-co-acrylic acid), poly(methyl methacrylate-co-methacrylic acid), poly(n-butyl acrylate-co-acrylic acid), poly(ethyl acrylate-co-acrylic acid), poly(n-butyl acrylate-co-acrylic acid), and poly(ethylene-co-acrylic acid).

Typical building blocks for poly(amic acids) and polyimides include dianhydrides such as 3,3′,4,4′-benzophenonetetracarboxylic dianhydride (BTDA), 4,4′-oxydiphthalic anhydride (ODPA), 2,2-bis(3,4-dicarboxyphenyl)hexafluoropropane dianhydride (6FDA), and pyromellitic dianhydride (PMDA). Representative diamines include but are not limited to 4,4′-oxydianiline (4,4′-ODA), 3,4′-oxydianiline (3,4′-ODA), 2,2-bis(3-aminophenyl)hexafluoropropane (6FA), 1,3-bis(3-aminophenoxy)benzene (APB), 2,2-bis[4-(4-aminophenoxy)phenyl]hexafluoropropane (4-BDAF), 3,5-diaminobenzoic acid (DABA).

Representative solvents useful in the synthesis of polyimides and poly(amic acids) include but are not limited to dimethylformamide (DMF), dimethylacetamide, N-methylpyrrolidinone (NMP), bis(2-methoxyethyl)ether (diglyme), 2-methoxyethanol, tetrahydrofuran, dimethylsulfoxide (DMSO), acetone, and ethyl methyl ketone.

Fabrication of Surface-Metallized Films

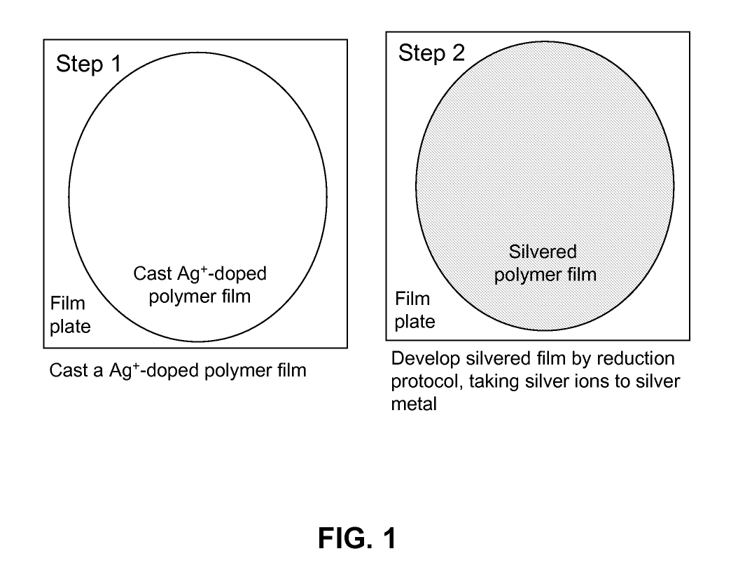

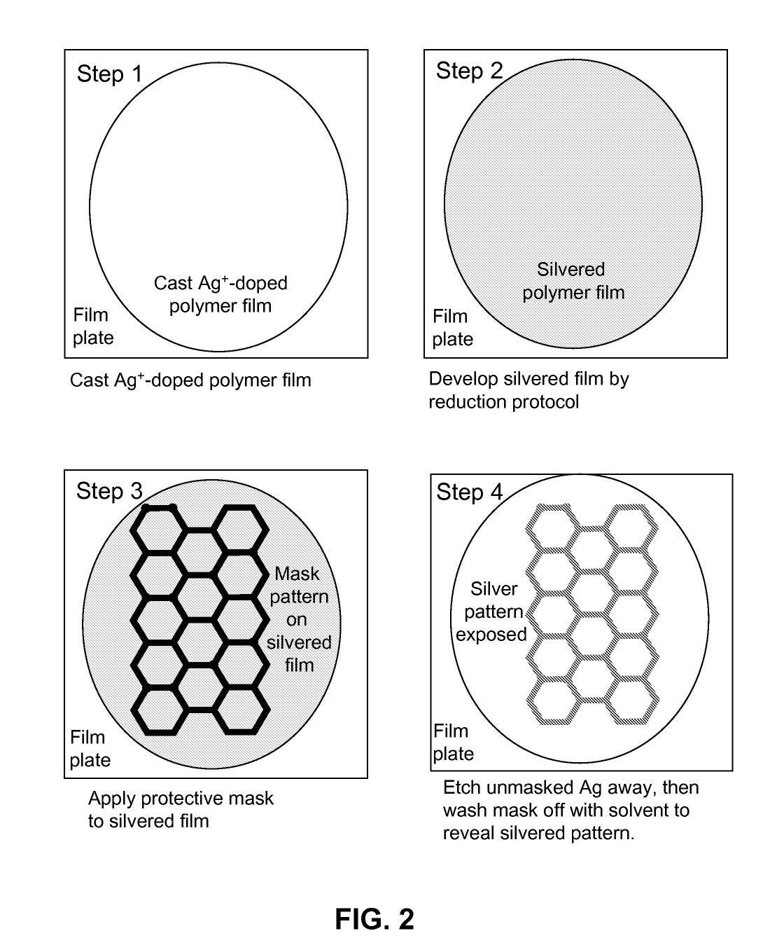

In FIG. 1, a schematic route to fabricate a continuously surface-silvered polymer film is presented. The use of the word “film” in the representative scheme of FIG. 1, and in FIGS. 2-5 as well, is meant to be illustrative of a process that could be applied alternatively to a variety of polymer constructions including coatings, objects, devices, articles, and structures on which a silver surface is desired.

To implement the fabrication of a continuously silvered polymer film as illustrated in FIG. 1, a suitable polymer with a pendant acid group is contained in a solvent, generally in the range of 5-25 weight percent polymer. To this solution of polymer, an amount of a silver(I) compound is added to give a weight percent silver, based on silver and polymer only, in the range of 0.1% to a maximum weight percent metal ion that is limited by the extent of the metal ion compound's solubility. The silver(I) compound is added directly to the polymer solution, or the silver(I) compound is dissolved in a small amount of solvent with subsequent addition of the silver(I) solution by pouring or syringing it into the polymer solution. The silver(I) ion-doped polymer solution is stirred to obtain a uniform solution. Exemplars of silver(I) compounds used in the preparation of silver(I) ion-doped polymers include, but are not limited to, silver(I) nitrate, silver(I) acetate, silver(I) tetrafluoroborate, (hexafluoroacetylacetonato)silver(I), (trifluoroacetylacetonato)silver(I), and 1-(2-thienyl)-3,3,3(trifluoroacetonato)silver(I), (3-cyanoacetylacetonato)silver(I), (trifluoroacetato)silver(I), (2,2-dimethyl-6,6,7,7,8,8,8-heptafluoro-3,5-octanedionato)silver, other silver(I) beta diketonates, (pentafluoropropionato)silver(I), (heptafluorobutyrato)silver(I), and (trifluoromethane sulfonato)silver(I). Protocols for preparing silver(I)-doped polymer solutions and films are known in the art (for example, see Davis, L. M.; Thompson, D. S.; Dean, C. J.; Pevzner, M.; Scott, J. L.; Broadwater, S. T.; Thompson, D. W.; Southward, R. E. Journal of Applied Polymer Science (2007), 103(4), 2409-2418).

With the silver(I) ion-doped polymer solution thus prepared, the solution is blade, spun, or otherwise cast as a film on a glass plate, silicon wafer, or other substrate as illustrated by the oval in Step 1 of FIG. 1. In one embodiment, the cast film on the plate is then placed in a box and flowing air (100-200 cu. ft./h) with a low relative humidity, e.g. 5%, is passed over the film until the film is depleted of solvent so as to be tack-free. Typically, the doped film is left in the box for 12-24 h. Alternatively, the film is depleted of solvent in a vacuum chamber operating at room temperature for a suitable period of time, e.g. two hours. After the doped film is depleted of solvent, it is removed from the film box and treated with an aqueous reducing agent such as hydroxylamine or hydrazine to develop the silvered surface as illustrated in Step 2 of FIG. 1. The film is submerged in a solution of the reducing agent, or alternatively the reducing solution can be placed on the film attached to the casting plate. The film may be pretreated with dilute aqueous ammonia to facilitate the reduction process. Alternatively, the film may be taken from the film box and heated, e.g., to a temperature in the range of 135° C. to 170° C., to remove small residual amounts of solvent before the film is treated with the reducing agent as described above. After reduction, the fully metallized film is dried in air or vacuum. If the surface-silvered film is a poly(amic acid), it may be used in the poly(amic acid) form or may be heated to a temperature sufficient (e.g., 275-300° C.) to convert the base polymer to the polyimide form.

In another embodiment, polymer precursors are dissolved in a suitable solvent along with silver ions. The polymer precursors are polymerized using methods known in the art, producing a polymer having pendant acid groups. A solid polymer article is produced from the resulting polymer, and then treated with a chemical reducing agent as described above.

Patterned silver surfaces can also be obtained according to various embodiments of the invention. For example, in one embodiment, silver(I)-doped polymer films as described above can be blade, spun, or otherwise cast as a film on a glass plate as illustrated by the oval in Step 1 of FIG. 2. Solvent is evaporated or removed by other means until the film is tack-free. After the doped film is depleted of solvent, it is removed from the film box and treated with an aqueous reducing agent such as hydroxylamine or hydrazine to develop the silvered surface as in Step 2 of FIG. 2. The film is submerged in a solution of the reducing agent, or the reducing agent is placed on the film attached to the casting plate. The film may be pretreated with dilute aqueous ammonia to speed the reduction process. Alternatively, the film can be taken from the film box and heated to remove small residual amounts of solvent before the film is treated with the reducing agent to give the fully metallized film. The fully metallized film is then dried in air or vacuum. In Step 3 of FIG. 2, the fully surface-metallized film is patterned by the ink-jet, screen, syringe, or otherwise printing or drawing of a masking agent. One approach is to draw a pattern onto the fully metallized surface of the film using a Sanford Permanent Marker pen. Such a pattern is illustrated in Step 3 of FIG. 2 by the array of hexagons. The masking agent is allowed to dry in air at room temperature or dried with the aid of a heat gun. In Step 4 of FIG. 2, the patterned surface-silvered film is placed in an etching bath, such as silver etchant type TFS solution supplied by Transene (Danvers, Mass. 01923), until the unmasked silver is removed. Subsequently, the mask is washed from the film with an appropriate solvent; in the case of the Sanford Permanent Marker, the mask is removed with ethanol. The resulting patterned metallized film is dried. The final film may be heated to further aggregate and/or sinter surface-silver particles and, as appropriate, increase the reflectivity and/or conductivity of the silver pattern.

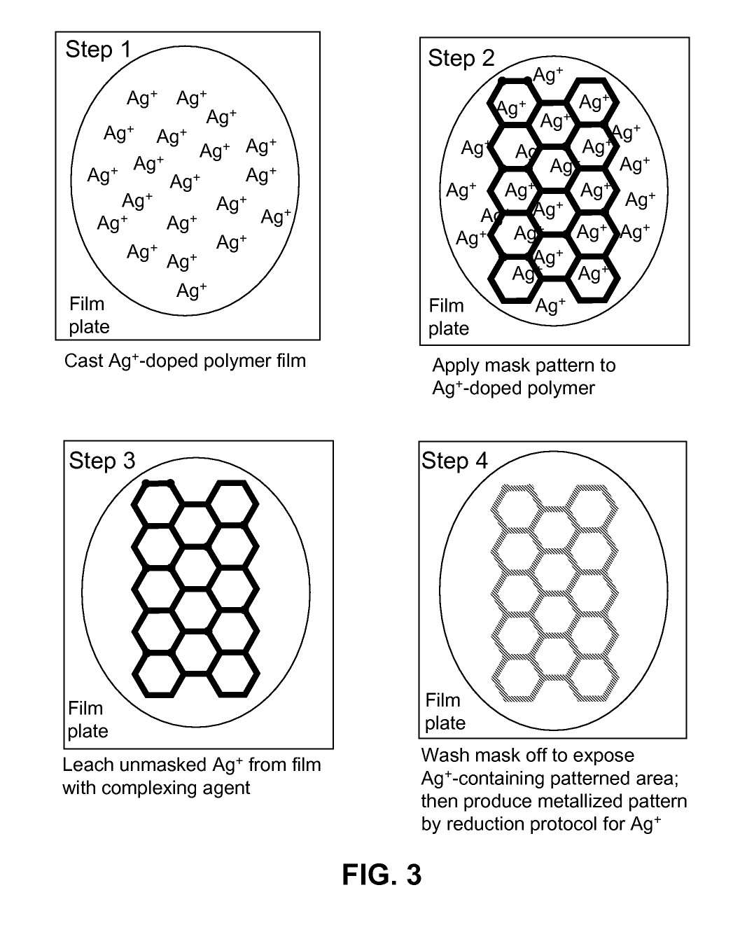

In another embodiment schematically described in FIG. 3 to produce a patterned silver surface, silver(I)-doped polymer films are blade, spun, or otherwise cast as a film on a glass plate as illustrated by the oval in Step 1 of FIG. 3. Subsequently, the cast silver ion-doped film is patterned by the ink-jet, screen, syringe, or otherwise printing or drawing of a masking agent, as illustrated in Step 2 of FIG. 3 by the array of hexagons. The masking agent is allowed to dry in air at room temperature or dried with the aid of a heat gun. As illustrated in Step 3 of FIG. 3, the patterned unreduced film is placed in a leaching bath to remove unmasked silver(I) ions. Leaching reagents include silver(I) complexing agents such as thiosulfate, ammonia, cyanide, and other suitable reagents. After the leaching step, the mask is washed from the film with an appropriate solvent. The remaining silver(I) ions are treated with an aqueous reducing agent such as hydroxylamine or hydrazine to develop the silvered pattern as illustrated in Step 4 of FIG. 3. The film can be, e.g., submerged in a solution of the reducing agent, or the reducing solution can be placed on the air-side of the cast film.

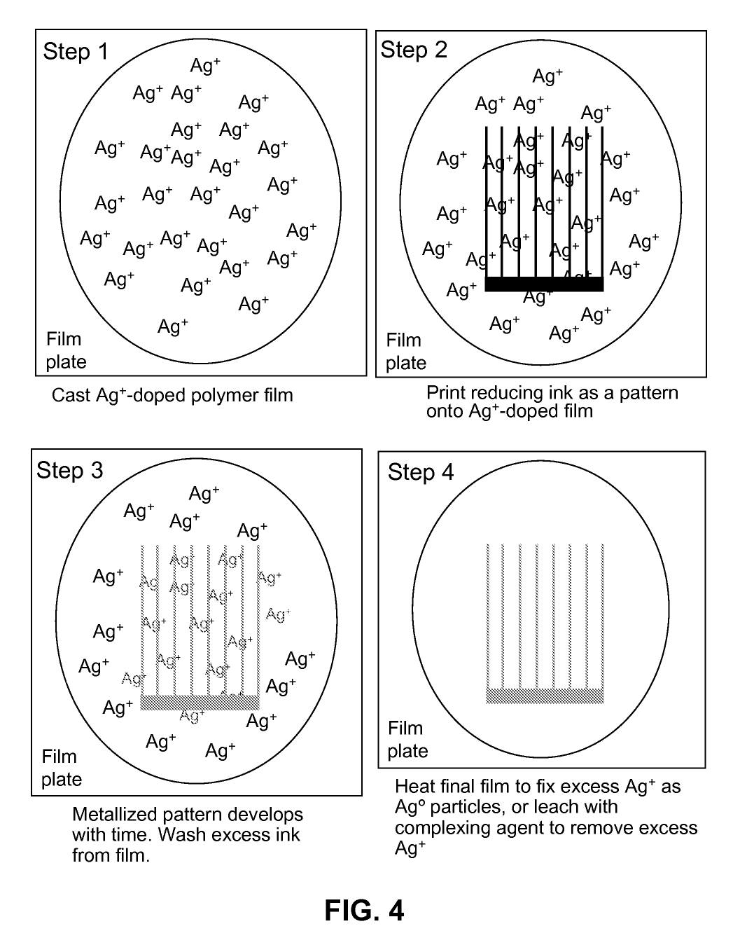

In another embodiment, a patterned silver surface can be produced using the schematic method diagrammed in FIG. 4. Silver(I)-doped polymer films are blade, spun, or otherwise cast as a film on a glass plate as illustrated by the oval in Step 1 of FIG. 4. In Step 2 of FIG. 4, a reducing ink consisting of a reducing agent such as hydroxylamine or hydrazine in an appropriate solvent such as ethylene glycol or water, having a suitable viscosity for printing, is printed onto the silver(I)-doped polymer film of Step 1 of FIG. 4. After a time, generally in the range of 5-600 seconds, the printed reducing agent pattern, illustrated by the connected grid lines in Steps 2 and 3 of FIG. 4, develops a metallic surface. The unreduced silver(I) may be left in the polymer film or leached from the polymer film using complexing agents such as thiosulfate, ammonia, or cyanide, as described above for Step 3 of FIG. 3, or fixed in the bulk of the polymer film by heating said film to a temperature sufficient to reduce the silver(I), as illustrated in Step 4 of FIG. 4. These methods yield a final silver pattern on the polymer article as illustrated in Step 4 of FIG. 4.

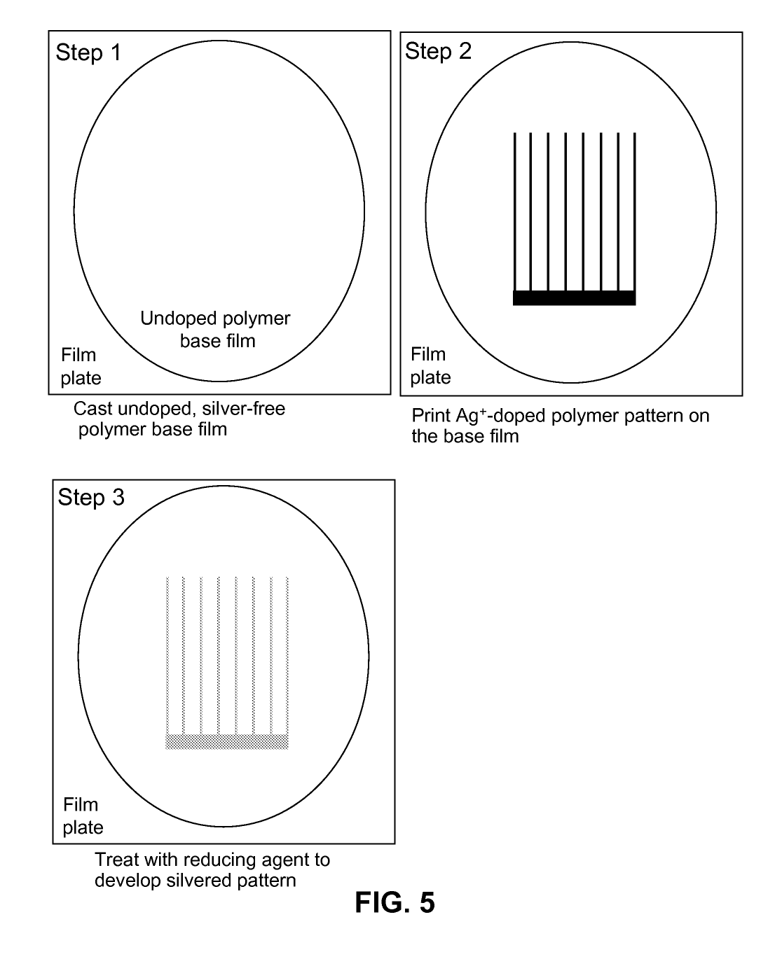

In another embodiment, a patterned silver surface on a polymer article can be produced using the schematic method diagrammed in FIG. 5. As illustrated in Step 1 of FIG. 5, an undoped, metal-free polymer film is cast as a base film. Onto this base a silver ion-doped polymer solution, as previously presented in FIGS. 1-4, is ink-jet, screen, syringe, brushed, or otherwise patterned onto the undoped, metal-free polymer base as illustrated in Step 2 of FIG. 5. The pattern is depleted of solvent by placing the patterned assembly in a box and flowing air (e.g., 100-200 cu. ft./h) with a low relative humidity, for example 5%, is passed over the film until the film is depleted of solvent so as to be tack-free. Alternatively, the film is depleted of solvent in a vacuum chamber operating at room temperature. After the pattern is depleted of solvent, the patterned assembly is treated with an aqueous reducing agent such as hydroxylamine or hydrazine to develop the silvered surface as illustrated in Step 3 of FIG. 5. The film is submerged in a solution of the reducing agent, or the reducing solution is placed on the air-side of the cast film. The film may be pretreated with dilute aqueous ammonia to speed the reduction process. Finally, the film may be heated, e.g., in the range of 150° C. to 200° C., to convert remaining silver(I) ions in the bulk to silver metal clusters.

### EXAMPLES

The examples that follow are intended in no way to limit the scope of this invention but are provided to illustrate representative embodiments of the present invention. Many other embodiments of this invention will be apparent to one skilled in the art.

### Example 1

3,3′,4,4′-Benzophenone tetracarboxylic dianhydride (BTDA)/4,4′-oxydianiline (4,4′-ODA) poly(amic acid) resin as a stock solution at 15 weight percent polymer in solvent was prepared by allowing 10.00 g (0.04994 mol) of 4,4′-ODA and 16.253 g (0.05044 mol) of BTDA to react in 149 g of dimethylacetamide (DMAc) contained in a 250 mL round-bottomed resin kettle. To remove water from the glassware prior to adding the reagents, the kettle was heated for several minutes with a heat gun while dry nitrogen gas was flowing through the system. The order of addition under nitrogen was diamine, then solvent, and then dianhydride. The polymerization reaction mixture was mechanically stirred for 5 h. Silver(I) acetate (0.262 g, 1.57 mmol), 1,1,1-trifluoro-2,4-pentanedione (0.274 g, 1.73 mmol), and pyridine (0.248 g, 3.14 mmol) were added to DMAc (1.0 g) and allowed to react for 10 minutes, after which 10.0 g of the BTDA/4,4′-ODA poly(amic acid) stock solution was added. After stirring the silver ion-doped poly(amic acid) solution for 30 minutes, a film was blade cast at a thickness of 0.60 mm onto a glass plate. The film was then placed at room temperature in a film box which was constructed to allow dry air to flow over the sample at 150 cu. ft./h. The silver(I) ion-doped film was kept in the box until the film was tack free. The tack-free film was removed from the box and heated (over 20 minutes) to 135° C., held at 135° C. for 1 h, and then heated to 140° C. at 0.69° C./min. The film was removed from the oven and allowed to cool to room temperature. The film was then immersed in a bath of 0.5 volume percent aqueous hydrazine for 15 minutes whereupon a silver surface developed on the air-side of the film. A two-point electrical resistivity measurement of the film found the film to be conductive in the metallic range; specifically, a two-point resistance at a probe spacing of 1 cm was 2 ohms. The film was highly specularly reflective to the eye.

### Example 2

3,3′,4,4′-Biphenyltetracarboxylic dianhydride (BPDA)/4,4′-oxydianiline (4,4′-ODA) poly(amic acid) resin was prepared as a stock solution at 15 weight percent polymer in solvent, as in Example 1, by allowing 10.00 g (0.04994 mol) of 4,4′-ODA and 14.841 g (0.05044 mol) of BTDA to react in 141 g of dimethylacetamide (DMAc). Silver(I) acetate (0.262 g, 1.57 mmol) and 1,1,1,5,5,5-hexafluoro-2,4-pentanedione (0.359 g, 1.73 mmol) were added to 1.5 g of DMAc. The resulting solution of the (1,1,1,5,5,5-hexafluoro-2,4-pentanedionato)silver(I) complex was stirred for several minutes, after which 10.12 g of the BPDA/4,4′-ODA poly(amic acid) stock solution was added. After stirring for 30 minutes, a film was blade cast at a thickness of 0.60 mm onto a glass plate. The film was then placed at room temperature in a film box which was constructed to allow dry air to flow over the sample at 150 cu. ft./h. The silver(I) ion-doped film was kept in the box until the film was tack-free. The tack-free film was removed from the box and heated (over 20 minutes) to 135° C., then removed from the oven and allowed to cool to the ambient temperature. The film was then immersed in a bath of 0.1 volume percent aqueous hydrazine for 15 min whereupon a silver surface developed on the air-side of the film. The two-point electrical resistance of the film was 2 ohms. The film was highly specularly reflective to the eye.

### Example 3

The polyimide form of the copolymer formed from 2,2′-bis(3,4-dicarboxyphenyl)hexafluoropropane dianhydride (6FDA) with an equimolar diamine mixture of 4,4′-oxydianiline (4,4′-ODA) and 3,5-diaminobenzoic acid (DABA) was formed in a 250-mL resin kettle. To remove water from the glassware, the kettle was heated for several minutes with a heat gun while dry nitrogen gas to flowing through the system. Under a slow flow of nitrogen gas DABA (3.016 g, 198.2 mmol) and 4,4′-ODA (3.972 g, 198.4 mmol) were added as solids directly to the kettle. DMAc (60 mL) was then added, and the mixture of diamines was dissolved by stirring. 6FDA (17.603 g, 396.3 mmol) was added as a solid directly to the resin kettle with the nitrogen slowly flowing. An additional 40 mL of DMAc were added. The final reaction mixture was stirred at room temperature for 15 h. The viscosity of the solution increased continually for the first one hour and then appeared to remain roughly constant. The poly(amic acid) prepared above was slowly poured (over a 5 minute period) into a magnetically stirred mixture containing 150 mL each of acetic anhydride and pyridine. The solution was then heated to 60° C. and stirred for 3 h. The solution was allowed to cool to the ambient temperature. A high-speed blender was assembled, and the polyimide solution was added over 30 minutes to the rapidly stirring blender containing 500 mL of deionized water through a dropping funnel. Periodically, cubes of ice were added to maintain the system near room temperature. The precipitated polyimide was filtered using a Buchner funnel, and washed with 500 mL of deionized water. The resulting solid polyimide was dried at 100° C. in air and then in a vacuum oven at 150° C. for 10 h. The isolated yield was 22.5 g or 97.1%.

A film containing 8.0 weight percent silver in the above copolymer, 6FDA/4,4′-ODA-DABA, was prepared as follows. Silver(I) oxide (0.172 g, 0.742 mmol) was added to a 12-mL glass jar, followed by 2.0 g of DMAc, trifluoromethane sulfonic acid (0.222 g, 1.48 mmol), and finally another 2.0 g of DMAc. The reaction mixture was stirred for 15 minutes to form (trifluoromethane sulfonato)silver(I). To this (trifluoromethane sulfonato)silver(I) solution, 2.00 g of the fully imidized form of 6FDA/4,4′-ODA-DABA was added, followed by 4.0 g DMAc. The resulting solution was stirred for 1 h. A film was cast onto a glass plate at a thickness of 0.45 mm with a doctor blade. The silver(I)-doped film was then placed in a film box for 15 h with dry air (relative humidity at 22° C.: 5%) flowing through the box to evaporate DMAc. The tack-free film was then treated with the following reducing agents, both with and without pre-treating the surface with 0.1 M aqueous ammonia: 1.0% methyl hydrazine, 1.0% hydroxylamine, and 1.0% hydrazine monohydrate. Methyl hydrazine gave slightly reflective surfaces, with a sheet resistivity of 19,000 ohms/square without ammonia treatment, and a sheet resistivity of 4,500 ohms/square with ammonia pre-treatment. Hydroxylamine afforded highly specularly reflective surfaces to the eye, with a sheet resistivity of 2.8 ohms/square without ammonia pre-treatment, and a sheet resistivity of 0.03 ohms/square with ammonia pre-treatment. Hydrazine also afforded highly specularly reflective surfaces to the eye, with a sheet resistivity of 1.8 ohms/square without ammonia pre-treatment, and a sheet resistivity of 0.03 ohms/square with ammonia pre-treatment.

### Example 4

2,2-Bis(3,4-dicarboxyphenyl)hexafluoropropane dianhydride (6FDA)/3,5-diaminobenzoic acid (DABA)-2,2-bis[4-(4-aminophenoxy)phenyl]hexafluoropropane (4-BDAF) poly(amic acid) copolymer resin was prepared by allowing 0.340 g (2.24 mmol) of DABA and 0.579 g (1.12 mmol) of 4-BDAF and 1.490 g (3.36 mmol) of 6FDA to react in 7.0 g of dimethylacetamide (DMAc), similarly to the procedure in Example 3. This poly(amic acid) solution was added to 40 mL of an acetic anhydride:pyridine solution (1:1 by volume). The solution was heated to 60° C. for 4 h to effect loss of water and cycloimidization of the poly(amic acid). The polyimide solution was dripped into 100 mL of water, whereupon the polyimide precipitated. This final polyimide was filtered, washed with 100 mL of water, and dried under vacuum at 150° C. for 6 h. Silver(I) acetate (0.262 g, 1.57 mmol) and 1,1,1,5,5,5-hexafluoro-2,4-pentanedione (0.359 g, 1.73 mmol) were added to 7.5 g of DMAc. To this solution of the (1,1,1,5,5,5-hexafluoroacetylacetonato)silver(I) complex, 1.4 g of the polyimide form of 6FDA/DABA-4-BDAF was added. The resulting silver(I) ion-containing polyimide solution was stirred for 1 h. A film was cast onto a glass plate at a thickness of 0.60 mm with a doctor blade. The film was then placed at room temperature in a film box which was constructed to allow dry air to flow over the sample at 150 cu. ft./h (relative humidity at 22° C.: 5%). The silver(I) ion-doped film was kept in the box for 15 h, until the film was tack-free. The tack-free film was removed from the box and was then immersed in a bath of 0.1 volume percent aqueous hydrazine for 15 minutes whereupon a silver surface developed on the air-side of the film. The two-point electrical resistance of the film was 2 ohms. The film was highly specularly reflective to the eye.

### Example 5

2,2-Bis(3,4-dicarboxyphenyl)hexafluoropropane dianhydride (6FDA)/3,5-diaminobenzoic acid (DABA) resin was prepared by allowing 0.510 g (3.36 mmol) of DABA and 1.490 g (3.36 mmol) of 6FDA to react in 7.0 g of dimethylacetamide (DMAc), similarly to the procedure in Example 3. This poly(amic acid) solution was added to 40 mL of an acetic anhydride:pyridine solution (1:1 by volume). The solution was heated to 60° C. for 4 h to effect loss of water and cycloimidization of the poly(amic acid). The polyimide solution was dripped into 100 mL of water, whereupon the polyimide precipitated. This final polyimide was filtered, washed with 100 mL of water, and dried under vacuum at 150° C. for 6 h. Silver(I) acetate (0.275 g, 1.65 mmol) and 1,1,1,5,5,5-hexafluoro-2,4-pentanedione (0.493 g, 2.37 mmol) were added to 7.1 g of DMAc. To this solution of the (1,1,1,5,5,5-hexafluoroacetylacetonato)silver(I) complex, 1.6 g of the polyimide form of 6FDA/DABA was added. The resulting silver(I) ion-containing polyimide solution was stirred for 1 h. A film was cast onto a glass plate at a thickness of 0.60 mm with a doctor blade. The film was then placed at room temperature in a film box which was constructed to allow dry air to flow over the sample at 150 cu. ft./h (relative humidity at 22° C.: 5%). The silver(I) ion-doped film was kept in the box for 15 h, until the film was tack-free. The tack-free film was removed from the box and was then immersed in a bath of 0.1 volume percent aqueous hydrazine for 15 min, whereupon a silver surface developed on the air-side of the film. The two-point electrical resistance of the film was 2 ohms. The film was highly specularly reflective to the eye.

### Example 6

Using a red Sanford Permanent Marker, a 1.0 mm line pattern was drawn on a 2 cm×2 cm piece of the silver(I) ion-doped polymer film of Example 2. This patterned silver ion-doped film was then placed in a stirring 0.32 M aqueous sodium thiosulfate solution for 15 min. The film was removed, rinsed with deionized water, and the line pattern washed off with ethanol. The film was finally placed in 0.1 volume percent hydroxyl amine for 10 min, whereupon the portion of the film previously covered with the line pattern mask became silvered with a two-point resistance of 35 ohms at a probe separation of 1 cm. Only the initially masked pattern developed a conductive silver surface.

### Example 7

A similarly prepared and thermally treated silver(I) ion-doped polymer film to that of Example 1 was fully metallized by treating the silver(I) ion-doped polymer film with 0.5 volume percent aqueous hydrazine monohydrate for 5 min. This fully surface-metallized film was line patterned with a red Sanford Permanent Marker as in Example 6. The line width was 0.5 mm. The line-patterned (i.e., line-masked) film was placed in a Transene (Danvers, Mass. 01923) silver etchant type TFS solution for 5 min. The unmasked, exposed silver surface of the film was completely removed. The line pattern mask was then washed from the film with ethanol to expose the silvered line pattern. Two-point resistance of the line was 10-15 ohms at 1.0 cm probe spacing.

### INCORPORATION BY REFERENCE

All publications, patents, and patent applications cited herein are hereby expressly incorporated by reference in their entirety and for all purposes to the same extent as if each was so individually denoted.

### EQUIVALENTS

While specific embodiments of the subject invention have been discussed, the above specification is illustrative and not restrictive. Many variations of the invention will become apparent to those skilled in the art upon review of this specification. The full scope of the invention should be determined by reference to the claims, along with their full scope of equivalents, and the specification, along with such variations.

The articles “a” and “an” are used herein to refer to one or to more than one (i.e. to at least one) of the grammatical object of the article. By way of example, “a polymer” means one polymer or more than one polymer.

Any ranges cited herein are inclusive.

We claim:

1. A method for forming a conductive silver surface on a solid polymer article comprising:
(i) dissolving silver ions in a solution comprising a polymer and a compatible solvent;
(ii) producing a solid polymer article from said solution; and
(iii) treating the surface of said solid polymer article with a chemical reducing agent;
wherein said polymer contains pendant acid groups.

2. The method of claim 1, wherein the ratio of acid groups to molecular weight of said acid-containing polymer is greater than 1:1,500.

3. The method of claim 1, wherein said polymer comprises poly(amic acid).

4. The method of claim 3, wherein said poly(amic acid) polymer is chemically imidized to form a polyimide subsequent to said step of producing a solid polymer article.

5. The method of claim 1, wherein said polymer is a polyimide.

6. The method of claim 1, wherein the conductive surface formed on the solid polymer article has electrical resistivity at 20° C. of less than 1.6×10⁻⁵ Ωm.

7. The method of claim 1, wherein the counterion to said silver ions is selected from the group consisting of beta-diketonates, carboxylates, and sulfonates.

8. The method of claim 7, wherein the counterion to said silver ions is a beta-diketonate selected from the group consisting of 1,1,1-trifluoro-2,4-pentanedionate, 1,1,1,5,5,5-hexafluoro-2,4-pentanedionate, 6,6,7,7,8,8,8-heptafluoro-3,5-octanedionate, 3-cyano-2,4-pentanedionate, and (4,4,4-trifluoro-1-(2-thienyl)-1,3-butanedionate.

9. The method of claim 7, wherein the counterion is a carboxylate selected from the group consisting of acetate, benzoate, trifluoroacetate, and perfluoropropionate.

10. The method of claim 1, wherein the concentration of polymer in the compatible solvent is between 1 percent and 50 percent on a weight by weight basis.

11. The method of claim 1, wherein the compatible solvent is selected from the group consisting of dimethylformamide, dimethylacetamide, N-methylpyrrolidinone, bis(2-methoxyethyl)ether, 2-methoxyethanol, tetrahydrofuran, dimethylsulfoxide, acetone, ethyl methyl ketone, and mixtures thereof.

12. The method of claim 1, wherein the compatible solvent is neat polymer.

13. The method of claim 1, wherein said solid polymer article is fabricated by a technique selected from the group consisting of spin casting, blade drawing, brushing, spraying, dipping, curtain coating, immersing, and printing.

14. The method of claim 1, wherein said solid polymer article is a film.

15. The method of claim 1, wherein the chemical reducing agent is selected from the group consisting of hydrazine, alkyl and aryl hydrazines, hydroxyl amine, alkyl and aryl hydroxyl amines, sodium borohydride, stannous chloride, hydroquinone, sodium sulfite, metol, sodium hypophosphinite, and mixtures thereof.

16. The method of claim 1, wherein the surface of said solid polymer article is treated with a vapor phase chemical reducing agent.

17. The method of claim 1, wherein prior to said step of treating the surface of said solid polymer article with a chemical reducing agent, the surface of said solid polymer article is subjected to treatment with an aqueous solution selected from the group consisting of aqueous ammonia, a derivative of ammonia in water, aqueous thiosulfate, aqueous cyanide solution, and mixtures thereof.

18. The method of claim 1, wherein said solid polymer article is subjected to additional masking and unmasking steps to produce a solid polymer article having a patterned silver conductive surface.

19. The method of claim 1, wherein the silver surface exhibits adhesion to the polymer article which is superior to the adhesion achieved by vapor deposition and electroless deposition of silver metal on neat polymer surfaces.

20. A method for forming a patterned silver conductive surface on a solid article comprising:
(i) dissolving silver ions in a solution comprising a polymer and a compatible solvent;
(ii) depositing said solution onto a solid article in a patterned format;
(iii) removing said compatible solvent; and
(iv) treating the surface of said solid polymer article with a chemical reducing agent;
wherein said polymer contains pendant acid groups.

21. The method of claim 20, wherein said process of depositing said solution onto a solid article in a patterned format is accomplished via printing said solution onto said solid article.

22. The method of claim 21, wherein said printing step comprises ink-jet printing.

23. The method of claim 21, wherein said printing step comprises screen printing.

24. A method for forming a conductive coating on the surface of a solid polymer article comprising:
(i) dissolving silver ions in a solution comprising polymer precursors;
(ii) polymerizing said polymer precursors;
(iii) producing a solid polymer article; and
(iv) treating the surface of said solid polymer article with a chemical reducing agent;
wherein said solid polymer article contains pendant acid groups.
